(19) United States
(12) Patent Application Publication
(10) Pub. No.: US 2011/0081251 A1
(43) Pub. Date: Apr. 7, 2011

(54) FREE-STANDING, IMMERSIBLE POWER GENERATION PLANT COMPRISING AN AXIAL TURBINE

(76) Inventors: Frank Biskup, Schwabusch Gmund (DE); Raphael Arlitt, UIm (DE); Ralf Starzmann, Sohnstetten (DE)

(21) Appl. No.: 12/735,612

(22) PCT Filed: Jan. 10, 2009
(86) PCT No.: PCT/EP2009/000098

§ 371 Date: Dec. 3, 2010

(30) Foreign Application Priority Data
Jan. 31, 2008 (DE) 10 2008 007 043.2

(51) Int. Cl. F03B 3/12

(52) U.S. Cl. 416/241 R

(57) ABSTRACT

The invention relates to an immersible power generation plant driven by a water flow, particularly a tidal current, comprising a water turbine in the form of an axial turbine with an associated rotational axis. The water turbine comprises at least one turbine blade that is designed such that the course of the threading line of the profile sections thereof deviates from the radial flow when projected on the rotational plane.

The invention relates to an immersible, free-standing power generation plant, comprising a water turbine which is arranged as an axial turbine of propeller-like shape.

Power generation plants which obtain energy from a water flow as free-standing units without any additional dam structures can be used especially as hydroelectric power stations, and especially for obtaining energy from an ocean current, especially a tidal current.

Immersible power generation plants with a support structure on which a water turbine in the form of an axial turbine revolves are known. Usually, the axial turbine comprises a hub with propeller-like turbine blades attached thereto. Such an axial turbine is in torsion-proof connection with a drive shaft mounted in a gondola housing, which shaft is usually used for driving an electric generator.

Reference is hereby made to EP 1 183 463 A1 and EP 1 540 172 A1 by way of example for free-standing immersible power generation plants. Propeller-like axial turbines are known from these specifications. The turbine blades are arranged in the form of radial-flow rotors along the circumference of a hub, i.e. it is possible to define at least one threading line of the profile sections for each of the turbine blades which extends in a straight line and faces in the radial direction in relation to the rotational axis of the axial turbine. Such a configuration of the turbine blades is characterized by high structural strength and is preferably chosen for immersing power generation plants for the high density of water as the driving medium in comparison with an air flow. A high moment is absorbed even in the case of radially small axial turbines for power generation plants, so that the entire installation ranging from the turbine blades to the support structure must be designed according to the high static and dynamic loads.

The invention is based on the object of providing a free-standing immersible power-generation plant which is arranged in such a way that only limited dynamic loads originate from the axial turbine and the entire installation can be arranged in a constructionally simple way especially concerning structural strength.

The object in accordance with the invention is achieved by the features of the independent claim. Advantageous further developments are disclosed by the dependent claims.

In the case of free-standing axial turbines whose rotational axis is disposed at an angular, mostly rectangular, position in relation to a support structure, pressure pulses occur during the passage of the rotor blades through the accumulation in front of the tower in the case of an upstream machine and through the tower shadow or unstable after-running area in the case of a downstream machine. These lead to temporally variable moments about an axis which extends perpendicularly to the longitudinal axis of the support structure and perpendicularly to the rotational axis of the axial turbine.

In order to ameliorate this problem it is proposed by the invention to incline and/or bend at least one turbine blade in the rotational plane against the radial direction. Preferably, an angular offset which is dependent on the radius is obtained in relation to the radial beam extending through the base point of the rotor blade over a wide part of the extension of the turbine blade.

Accordingly, the invention is characterized in a first development by turbine blades of an axial turbine for an immersible power generation plant for which the projection of the threading line of the profile sections in the rotational plane does not face exclusively in the radial direction or deviates from the course of the radial beam. This deviation leads to radius-dependent angular offset in relation to the radial beam at least in partial sections of the threading line.

For an advantageous further development of the invention, the threading line of the profile sections is additionally guided out of the rotational plane, with the tip of the turbine blade preferably being spaced farther from the support structure than the base point of the turbine blade. This can occur in a course of the threading line which is straight at least in sections or in a curved manner.

For one arrangement variant of the invention there is a curved threading line for the projection into an intersecting plane containing the rotational axis, whereas the projection into the rotational plane, for which the rotational axis represents the surface normal, extends radially. Accordingly, the curvature faces towards upstream or downstream, preferably away from the supporting structure. Especially in the case of an upstream machine, the eddies occurring on the edge on the downstream side along the longitudinal extension of the rotor blades meet the support structure, with the rapidly revolving rotor blade tips being spaced especially far from the support structure as a result of the curvature of the threading line. This is especially advantageous with respect to the acoustics of the installation and the necessary structural strength of the components of the installation.

In this case, the term “rotational plane” of the axial turbine shall be understood to be a plane to which the rotational axis forms a surface normal and which intersects the base point of at least one turbine blade. The base point is determined at the section of the threading line with the support structure of the turbine blade, typically a hub.

The threading line represents the connecting line of a defined point of the profile sections of a turbine blade. A point thus defined can be the point of intersection of the skeleton line with the mean line of the profile section. Usually, the point is chosen in the skeleton line for determining the threading line which is disposed at one quarter of the profile depth. For a large number of profiles this point represents approximately the moment-free force application point. The geometrical condition of a deviation from the course of radial beam in the rotational plane shall be provided within the scope of the invention for any possible determination of the threading line.

As a result of the deviation from the usual radial progression for the projection of the threading line onto the rotational plane, each of the turbine blades does not pass the region in the flow field which is influenced by the support structure with the entire longitudinal extension of the turbine blade at the same time. Instead, this area of action for a turbine blade is passed at different times according to its shape engaging in space, thus reducing torque jerks which occur in a pulse-like manner.

Such a deviation of the projection of the threading line into the rotational plane is applied to a turbine blade with the geometry in accordance with the invention, thus effectively reducing the pressure pulses. The degree of inclination and/or curvature of the projection of the threading line against the radial line will depend on several factors, which are especially the flow speed, the dimension of the support structure, the number, extension and size of the turbine blades. For a preferred arrangement, there will be a minimum angular deviation of at least 10° for the region of the largest forward or rearward position against the radial beam. The angular deviation is measured between the radial beam and a straight line which is determined by the point on the threading line belonging to the respective profile section and the penetration point of the rotational axis through the rotational planes. Furthermore, arrangements are possible for which a forward or rearward position in relation to the radial beam is present only over a part of the longitudinal extension of the turbine blade. The curvature and/or inclination of the threading line is preferably provided for at least one third of the longitudinal extension, with the region of the tips of the turbine blades being most influential.

Further reduced pressure pulses occur for a turbine blade whose threading line of the profile sections is guided at least partly out of the rotational plane of the axial turbine. This follows from the fact that the region of accumulation in front of the tower and the region in the shadow of the tower over the longitudinal extension of the turbine blade is not passed in a corresponding axial distance to the support structure. An arrangement is especially preferable for which the rapidly revolving tip of at least one turbine blade is arranged at a larger distance from the support structure than the hub-side end of the turbine blade.

Pressure pulsations during the revolving of an axial turbine arranged in the manner of a propeller are reduced for a power generation plant in accordance with the invention. This leads to the advantage of smoother quiet running in comparison with a radial beam geometry which leads to structurally stiffer turbine blade configurations, so that the less stiff geometry of curved or inclined turbine blades leads to advantages when regarded in general. Accordingly, the entire installation can be configured with lower requirements concerning structural strength. This relates both to the axial turbine itself as well as all following structural components right up to the support structure. The reduction of the dynamic loads further improves the fatigue behavior and the service life of the installation.

In addition to the inclination or curvature of the threading line of the turbine blades projected onto the rotational plane, further measures can be taken which reduce the effect of the influence on flow by the support structure on the turbine blades. One of the measures is to space the axial turbine as far as possible in the direction of the rotational axis away from the support structure. Usually, a gondola housing is provided between the hub of the axial turbine and the support structure, in which transmission and generator components are housed. For an especially advantageous arrangement, the gondola housing is provided with an axially long configuration and comprises an axial spacer element. As a further additional measure, the support structure can be arranged at least in sections in streamlined fashion. In the case of a support structure in the form of a tower, it is appropriate to arrange the cross section in an asymmetric manner. Especially elliptical or tapering cross sections at both axial ends can be considered in particular.

The inventive deviation of the threading line of the profile sections of the turbine blades from an exclusively radial progression further leads to an acoustic improvement of the immersible power generation plant, with the reduced noise generation having a lower impact on the fauna in the ambient environment of the immersible power generation plant. Turbine blades shaped in the manner of a sickle are especially preferred.

The noise reduction is also provided for a support structure arranged in a rotationally symmetrical way with the turbine blade geometry in accordance with the invention. Such a support structure can be given for example for a configuration which floats in the water and is anchored with a cable system. The upstream region is then influenced in a substantially symmetrical way, whereas the problems as described above are still provided in the downstream region as a result of the instabilities present there. For a further development, the noise generation is reduced for an axial turbine with a plurality of turbine blades by a course of the threading line which is chosen to be different from turbine blade to turbine blade. Accordingly, there is also a break in the symmetry concerning the turbine blade geometries in the circumferential direction for this arrangement variant.

The invention will now be explained in closer detail by reference to embodiments and diagrams shown in the drawings, which show in detail:

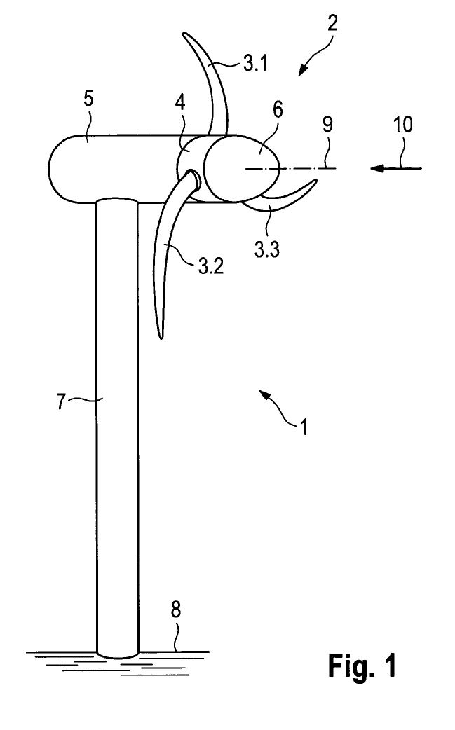

FIG. 1 shows an immersible power generation plant in accordance with the invention, comprising an axial turbine in a perspective view which comprises turbine blades shaped in the manner of a sickle for the projection into the rotational plane;

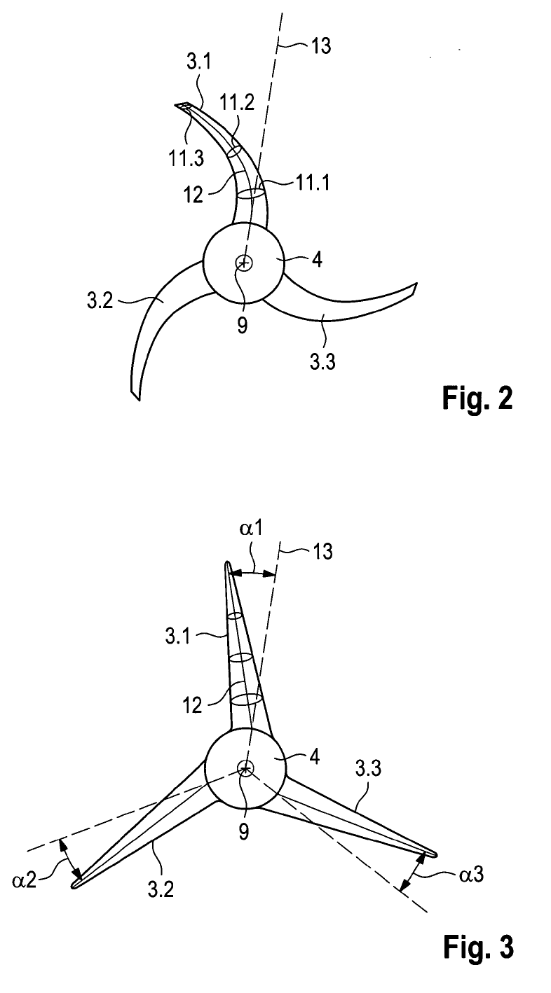

FIG. 2 shows a top view of an axial turbine in the direction predetermined by the rotational axis, with the axial turbine having sickle-shaped turbine blades for a projection into the rotational plane;

FIG. 3 shows a view corresponding to FIG. 2 for an arrangement with a straight threading line in the rotational plane which is inclined relative to the radial direction;

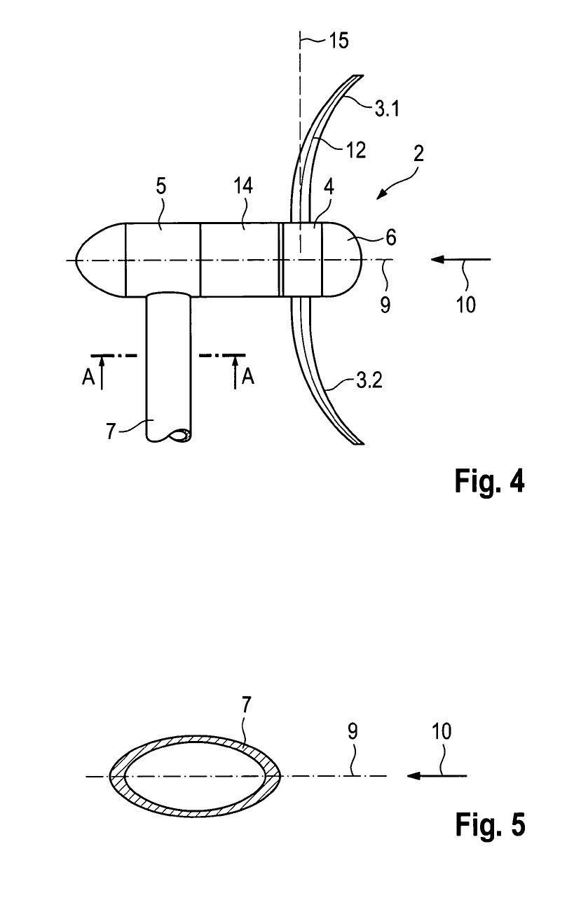

FIG. 4 shows an immersible power generation plant in accordance with the invention in a longitudinal sectional view with sickle-shaped turbine blades for an axial turbine, with the turbine blades having a curvature towards the outer end which faces away from the support structure;

FIG. 5 shows an arrangement for a streamlined cross section of the support structure for an immersible power generation plant in accordance with the section A-A of FIG. 4.

FIG. 1 shows a schematically simplified perspective view of an immersible power generation plant 1 in accordance with the invention. It generically comprises a water turbine which is arranged as an axial turbine 2. In this case, an axial turbine 2 with three turbine blades 3.1, 3.2, 3.3 is used which are arranged along the circumferential surface of a hub 4 at an angular distance of 120°. The axial turbine 2 revolves together with cap 6 on the gondola housing. Typically, a drive shaft which is not shown in detail in FIG. 1 is in torsionally rigid connection with the axial turbine 2. Usually, the drive shaft transfers the driving moment at least indirectly to an electric generator (not shown).

For the arrangement as shown in FIG. 1, the gondola housing 5 is fixed to a support structure 7 which is fixed to the ground 8 as a cylindrical tower for the illustrated arrangement. The term “support structure” will be used in a generalized way for the present application and can also designated a floating unit with which the axial turbine 2 is connected at least indirectly.

The support structure 7 represents a flow obstruction and forms a water head in front of the tower in the upstream direction for an upstream machine according to FIG. 1. During each passage of the turbine blades through this water head there will be a pressure pulse. The same problem arises in the case of a downstream machine. In this case the support structure is upstream in relation to the rotational plane of the axial turbine 2, thus producing a tower shadow. The inflow speed will drop locally in the tower shadow or the flow is influenced otherwise by the support structure 7. In the problematic case, an instationary flow in the form of a vortex street will arise.

The turbine blades 3.1, 3.2, 3.3 for an axial turbine 2 of an immersible power generation plant 1 in accordance with the invention deviate from the radial direction along their longitudinal extension with respect to the projection into the rotational plane. This is shown for two exemplary arrangements in FIGS. 2 and 3. The radial beam 13 is regarded as the radial line passing through the base point of the respective turbine blade in the direction of rotational axis 9. In accordance with the arrangement as shown in FIG. 2, the turbine blades 3.1, 3.2, 3.3 have a sickle-shaped progression of the threading line 12 for the projection onto the rotational plane.

The threading line 12 can comprise an additional directional component which faces in the direction of the normal to the rotational plane of the axial turbine 2.

Within the scope of the invention, the profile sections can be of any shape. In particular, the profiles of the three-digit Gottingen profile family will be considered, with the profile progression of the turbine blades 3.1, 3.2, 3.3 being arranged as an airfoil profile. It is further possible to use a profile with bidirectional inflow, especially a point-symmetrical one. Moreover, the turbine blades, and their profile sections respectively, can assume a predetermined angular position in relation to the inflow direction 10. It is further possible to arrange the turbine blades 3.1, 3.2, 3.3 to be connected to the hub in a torsionally rigid manner, or to assign the same to an angular adjustment mechanism (pitch).

FIG. 3 shows an arrangement of the invention, for which the progression of a threading line 12 of the turbine blades 3.1, 3.2, 3.3 is not sickle-shaped but in a straight line for the projection into the rotational plane, in contrast to the arrangement in accordance with FIG. 2. The progression of the threading line 12 has an angular deviation from the radial direction which is illustrated in FIG. 3 for the respective turbine blades by the reference numerals α1, α2 and α3. In accordance with a noise-reduced arrangement, the angular deviations from the radial beam α1, α2 and α3 deviate from one another, so that a symmetry break is applied in the circumferential direction.

In accordance with a further development of the invention, the radially outer region of the turbine blades 3.1, 3.2, 3.3 is arranged in such a way that in the case of occurring cavity bubbles they will be guided over a reduced area of the turbine blades in order to thus limit the potential for damage. In the case of a flow with partial radial components, this is achieved by curving or bending the rear edge of the rotor blades in the direction of rotation, i.e. the threading line precedes the radial beam in the radially outer region.

The deviation of the progression of the threading line 12 in relation to the radial direction can lead a turbine blade out of the rotational plane 15 of the axial turbine 2. One example for such an arrangement is shown in FIG. 4 in a longitudinal sectional view through an immersible power generation plant in accordance with the invention. It shows a sickle-shaped progression of the threading line in a plane which is predetermined by the radial direction 13 and the rotational axis 9. Accordingly, the outer ends of the turbine blades 3.1, 3.2 protrude forwardly or rearwardly in relation to the rotational plane.

For the advantageous arrangement as shown in FIG. 4, the ends of the turbine blades 3.1, 3.2 face upstream for the illustrated downstream machine, so that especially the rapidly revolving parts of the turbine blades 3.1, 3.2, which are the tips of the turbine blades, have a farther distance in the direction of the rotational axis of the axial turbine 2 from the support structure 7 than the regions close to the hub. Consequently, the turbine blades 3.1, 3.2 pass through the water head in front of the tower over a certain axial distance along their longitudinal extension at a predetermined time, with the turbine blade tip engaging in a region of lower influence by the support structure. The pressure pulses generated by the water head in front of the tower can be ameliorated further.

Additional measures are taken for a further arrangement in addition to the geometric arrangement of the turbine blades 3.1, 3.2 of the axial turbine 2 in accordance with the invention, which measures reduce the influence of the water head in front of the tower or the tower shadow (not shown in FIG. 4). An axial spacer element 14 is used for this purpose which extends the gondola housing 5 in the axial direction and spaces the axial turbine 2 farther from the support structure 7. The support structure 7 can additionally or alternatively be arranged to be streamlined. A streamlined shape is chosen in an exemplary manner for a cross section according to the line of intersection A-A in FIG. 4, which is shown in FIG. 5 on an enlarged scale. A cross section is shown which is chosen to be streamlined and which is stretched in an elongated manner in a direction extending parallel to the rotational axis 9 of the axial turbine 2. Elliptical cross sections or other flattened ones are considered, so that the nose of the cross section on the inflow side causes a low inflow resistance and the flow outlet on the downstream side is disturbed as little as possible.

Further modifications of the invention are possible within the scope of the following claims.

As a result of the shaping in the form of a sickle over the entire blade and with an angle of 38° at the tip of the blade, the tilting moments can be reduced by up to 20%. In the case of downstream machines these moments are three to four times larger than in the case of downstream machines of tidal current turbines. That is why the reduction of by means of sickle shaping is relevant.

Large forces occur in tidal current systems by the hydrodynamic flow. They can be reduced by sickle shaping.

### LIST OF REFERENCE NUMERALS

1 Immersible power generation plant
2 Axial turbine
3.1, 3.2, 3.3 Turbine blade
4 Hub
5 Gondola housing
6 Cap
7 Support structure
8 Ground of water
9 Rotational axis
10 Inflow direction
11.1, 11.2, 11.3 Profile section
12 Threading line
13 Radial beam
α1, α2 and α3 Angular deviation of the threading line in relation to the radial beam in the rotational plane
14 Axial spacer element
15 Rotational plane

1-9. (canceled)

10. An immersible power generation plant, driven by a tidal current, comprising:
a water turbine in the form of an axial turbine with propeller-shaped turbine blades and an associated rotational axis, with the axial turbine being fastened to a support structure arranged as a tower and the axial turbine is associated with a rotational plane which is determined as a surface normal by the rotational axis and a base point of a turbine blade;
the turbine blades have an airfoil profile, with the profile sections being arranged along a threading line in the direction radially to the outside with a continuously decreasing profile depth;
characterized in that
the turbine blades are arranged in such a way that the progression of the threading line of the respective profile sections projected onto the rotational plane of the axial turbine deviates from the radial beam and is curved when projected onto a plane being perpendicular to the rotational plane, so that the threading line has a directional component facing away from the support structure.

11. The immersible power generation plant according to claim 10, characterized in that the flow against the turbine blades can be bidirectional.

12. The immersible power generation plant according to claim 11, characterized in that the projection of the threading line onto the rotational plane extends in a straight line and assumes a non-disappearing angular deviation in relation to the radial beam.

13. The immersible power generation plant according to claim 10, characterized in that the projection of the threading line onto the rotational plane extends in a straight line and assumes a non-disappearing angular deviation in relation to the radial beam.

14. The immersible power generation plant according to claim 11, characterized in that the projection of the threading line to the rotational plane has a curved progression.

15. The immersible power generation plant according to claim 10, characterized in that the projection of the threading line to the rotational plane has a curved progression.

16. The immersible power generation plant according to claim 10, characterized in that the region of the largest forward position or rearward position of the projection of the threading line in relation to the radial beam has a minimum angular deviation of at least 10° from the radial beam.

17. The immersible power generation plant according to claim 11, characterized in that the region of the largest forward position or rearward position of the projection of the threading line in relation to the radial beam has a minimum angular deviation of at least 10° from the radial beam.

18. The immersible power generation plant according to claim 12, characterized in that the region of the largest forward position or rearward position of the projection of the threading line in relation to the radial beam has a minimum angular deviation of at least 10° from the radial beam.

19. The immersible power generation plant according to claim 13, characterized in that the region of the largest forward position or rearward position of the projection of the threading line in relation to the radial beam has a minimum angular deviation of at least 10° from the radial beam.

20. The immersible power generation plant according to claim 14, characterized in that the region of the largest forward position or rearward position of the projection of the threading line in relation to the radial beam has a minimum angular deviation of at least 10° from the radial beam.

21. The immersible power generation plant according to claim 15, characterized in that the region of the largest forward position or rearward position of the projection of the threading line in relation to the radial beam has a minimum angular deviation of at least 10° from the radial beam.

22. The immersible power generation plant according to claim 10, characterized in that the threading line has a component extending parallel to the rotational axis in at least one partial section.

23. The immersible power generation plant according to claim 11, characterized in that the threading line has a component extending parallel to the rotational axis in at least one partial section.

24. The immersible power generation plant according to claim 12, characterized in that the threading line has a component extending parallel to the rotational axis in at least one partial section.

25. The immersible power generation plant according to claim 13, characterized in that the threading line has a component extending parallel to the rotational axis in at least one partial section.

26. The immersible power generation plant according to claim 14, characterized in that the threading line has a component extending parallel to the rotational axis in at least one partial section.

27. The immersible power generation plant according to claim 10, further comprising a support structure which is asymmetrical in relation to the rotational axis of the axial turbine.

28. The immersible power generation plant according to claim 10, characterized in that an axial spacer element is provided between the support structure and the water turbine, which spacer element spaces the water turbine from the support structure in the direction of the rotational axis.

29. The immersible power generation plant according to claim 10, characterized in that the support structure is arranged to be streamlined at least in partial sections in order to reduce the tower shadow and/or the water head in front of the tower.
